(19) United States
(12) Patent Application Publication
(10) Pub. No.: US 2015/0258859 A1
(43) Pub. Date: Sep. 17, 2015

(54) AERODYNAMIC TIRE TREAD

(71) Applicant: Garth L. Magee, HAWTHORNE, CA (US)

(72) Inventor: Garth L. Magee, HAWTHORNE, CA (US)

(21) Appl. No.: 14/727,832

(22) Filed: Jun. 1, 2015

Related U.S. Application Data
(62) Division of application No. 13/799,005, filed on Mar. 13, 2013.

(51) Int. Cl. B60C 11/03; B60C 11/11

(52) U.S. Cl. CPC B60C 11/0327; B60C 11/0302; B60C 11/11; B60C 2011/0337

(57) ABSTRACT

A tire having streamlined tread blocks arranged in an aerodynamic pattern for reduced drag on forward-facing critical vehicle-drag-inducing upper wheel surfaces.

### CROSS-REFERENCE TO RELATED APPLICATION

This is a division of application Ser. No. 13/799,005, filed Mar. 13, 2013, currently pending, by the present inventor.

### BACKGROUND

1. Field

The present embodiment relates to vehicle wheels, and particularly to shields and devices used to reduce drag on rotating vehicle wheels.

2. Description of Prior Art

Inherently characteristic of rotating vehicle wheels, and particularly of spoked wheels, aerodynamic resistance, or parasitic drag, is an unwanted source of energy loss in propelling a vehicle. Parasitic drag on a wheel includes viscous drag components of form (or pressure) drag and frictional drag. Form drag on a wheel generally arises from the circular profile of a wheel moving though air at the velocity of the vehicle. The displacement of air around a moving object creates a difference in pressure between the forward and trailing surfaces, resulting in a drag force that is highly dependent on the relative wind speed acting thereon. Streamlining the wheel surfaces can reduce the pressure differential, reducing form drag.

Frictional drag forces also depend on the speed of wind impinging exposed surfaces, and arise from the contact of air moving over surfaces. Both of these types of drag forces arise generally in proportion to the square of the relative wind speed, per the drag equation. Streamlined design profiles are generally employed to reduce both of these components of drag force.

The unique geometry of a wheel used on a vehicle includes motion both in translation and in rotation; the entire circular outline of the wheel translates at the vehicle speed, and the wheel rotates about the axle at a rate consistent with the vehicle speed. Form drag forces arising from the moving outline are apparent, as the translational motion of the wheel rim must displace air immediately in front of the wheel (and replace air immediately behind it). These form drag forces arising across the entire vertical profile of the wheel are therefore generally related to the velocity of the vehicle.

As the forward profile of a wheel facing the direction of vehicle motion is generally symmetric in shape, and as the circular outline of a wheel rim moves forward at the speed of the vehicle, these form drag forces are often considered uniformly distributed across the entire forward facing profile of a moving wheel (although streamlined cycle rims can affect this distribution somewhat). This uniform distribution of pressure force is generally considered centered on the forward vertical wheel profile, and thereby in direct opposition to the propulsive force applied at the axle, as illustrated in FIG. 24.

However, as will be shown, frictional drag forces are not uniformly distributed with elevation on the wheel, as they are not uniformly related to the speed of the moving outline of the wheel rim. Instead, frictional drag forces on the wheel surfaces are highly variable and depend on their elevation above the ground. Frictional drag must be considered separate from form drag forces, and can be more significant sources of overall drag on the wheel and, as will be shown, thereby on the vehicle.

The motion of wheel spokes through air creates considerable drag, especially at higher relative wind speeds. This energy loss is particularly critical in both bicycle locomotion and in high-speed vehicle locomotion.

In sports cars, wheel covers have been employed to reduce aerodynamic vortices from developing inside the inner wheel assembly. These covers smooth the air flowing over the outer wheel and deflect a portion of the air to the brake linings, providing cooling thereon. In addition, various wings attached to the body of the car have been employed to deflect air around the drag-inducing exposed wheels. Such wings are generally located low to the ground, and are often configured to deflect air to one side or the other of exposed wheels, or to provide vehicle down-forces to counteract significant lifting forces generated by the exposed wheels. As will be shown, use of these wings to deflect air upwards onto the upper wheel can actually augment the down force problem, as well as contribute to more overall vehicle drag. And related flip-up deflectors have been incorporated into the body molding of some sports cars, although these have been generally limited to placement in front of the semi-exposed rearmost wheel. Such flip-up deflectors have also been used to augment down-forces in order to enhance vehicle stability at high speeds.

In various cycles, fenders and mud-covers have been used to cover wheels for other purposes. However, these items are generally oriented on the cycle consistent with their intended purpose of shielding the rider from debris ejected from the wheel. As such, they are not necessarily designed to be either forwardly positioned, nor closely fitted to the tire and wheel for aerodynamic shielding purposes.

Perhaps because aerodynamic devices are generally not allowed by rules governing many bicycle competitions, development of fairings for bicycles remains somewhat limited. Instead, fairings have been generally used to cover either the entire cycle, or the broad front area of the cycle, shielding both rider and cycle. Enclosing-type fairings typically have quite large surface areas, which augment frictional drag forces, largely negating any benefit in reducing form drag from streamlining the forward profile of the bicycle. Nevertheless, numerous bicycle speed records have been achieved using these larger fairings, validating their effectiveness. Frontal wind-deflecting fairings are typically used to reduce form drag on various components on a cycle; however, their greatly expanded surface areas can minimize their effectiveness by introducing greater frictional drag. The potential effectiveness of using smaller fairings—having minimal form and friction drag—for shielding specific, critical, drag-sensitive areas of moving wheel surfaces has not been properly recognized.

A study by Sunter and Sayers (2001), Aerodynamic Drag Mountain Bike Tyres, Sports Engineering, 4, 63-73, proposed and tested the use of a front-mounted wind-deflector fender for relatively low-speed, rough-surfaced, down-hill racing mountain bicycle front wheels. However, as will be shown, the tested fender was unnecessarily extensive; its extended design—covering the tire to well below the level of the axle—failed to focus properly on key sources of drag on a typical bicycle wheel. Instead, in this investigation, variations in drag were measured with differing tire tread patterns, and differing fender clearances, using knobby mountain bike tires, and were measured on the front wheel only. Moreover, sufficient fender clearances with the tire were investigated, with the aim of determining any potential benefit in reducing drag on the bicycle against the potential mud accumulation there-between.

Referencing an earlier study, Kyle (1985) Aerodynamic Wheels. Bicycling, December, 121-124, in this later study, Sunter and Sayers noted a 30% increase in drag on a wheel rotating with a speed equivalent to the exposed headwind, versus a stationary wheel exposed to the same headwind. As reported, this measurement seems to have represented the increase in torque needed to rotate the wheel about the axle. However, the change in torque measured about the axle on a fixed wheel mounted in an air-stream—as will be shown—cannot be considered an accurate representation of the change in drag force required to propel the bicycle. Torque measured this way is only an indirect factor needed to determine the effects on overall bicycle drag. As will be shown, the net drag force is generally not well centered on the rotating bicycle wheel, causing drag forces on the upper wheel to be magnified. Indeed, the offset drag force on the wheel contributes significantly more to overall bicycle drag than commonly understood.

A number of studies of bicycle wheel drag measured in wind tunnels also fail recognize the importance of drag forces on the upper wheel. Tests are typically conducted with the wheel suspended in the airstream, with the drag on the wheel measured via force gauges attached to the suspension arm. As will be shown, the magnification of upper wheel drag forces occurs when the wheel is in contact with the ground. Measuring drag on wheels suspended in an airstream will yield incomplete results, particularly for application to moving vehicles.

For example, an earlier study by Greenwell et al, Aerodynamic characteristics of low-drag bicycle wheels, Aeronautical Journal, 1995, 99, 109-120, measured translational drag on a wheel suspended from a torsion tube in a wind tunnel, where the wheel was driven by a motor and made no contact with a ground plane. They concluded that in this configuration—unexpectedly—rotational speed had little influence on the translational drag force directed upon the wheel assembly.

In a more recent study, Moore and Bloomfield, Translational and rotational aerodynamic drag of composite construction bicycle wheels, Proceedings of the Institution of Mechanical Engineers, Part P: Journal of Sports Engineering and Technology Jun. 1, 2008, vol. 222, no. 2, 91-102, the measured drag was extended to include rotational drag on the wheel. However, this study also failed to include a ground plane in contact with the wheel; the wheel remained suspended wind tunnel. As mentioned, this configuration does not accurately reflect the total retarding force upon a vehicle in motion caused by drag forces on the wheel. Sunter and Sayers also failed to recognize the magnifying effect that an off-center net drag force on the wheel can have on overall bicycle drag. Instead, they concluded that with the modest improvement in drag torque measured upon the rotating wheel using the wind-deflecting fender, only corresponding modest improvement in overall bicycle drag could be expected. They further concluded that the use of extensive front-wheel wind-deflecting fenders—having a rather large forward profiles—might thus prove beneficial in the specific application of mountain bicycle downhill racing, where only modest reductions in overall drag might yield a winning advantage in higher speed races. This conclusion would be consistent with the faulty observation that total drag forces are generally well centered on the wheel.

It has long been recognized that minimizing drag on large trucks and their trailers has significant potential for improving fuel economies. Extensive wind deflectors have been used in front of the rear wheels on extended truck trailers, but are generally designed to deflect very large volumes of air to the either side of the rear wheels. Deflecting unnecessary volumes of air with large fairings, can produce significant form drag by the fairing itself, thereby negating much of the intended benefit in reducing wheel drag. And as will be shown, deflecting air below the level of the axle can be particularly detrimental in reducing overall vehicle drag.

Tires are generally designed with tread patterns intended to maximize fraction with the road surface and to minimize rolling friction and road noise. A wide variety of tread patterns exist, each designed for specific vehicle applications. Some tires with aggressive tread patterns are designed for maximum fraction in off-road conditions. These tires generally have square or rectangular lugged patterns in the tread, and suffer from increased road noise and wind resistance. The need for tires with aggressive tread patterns specifically designed to reduce drag on the vehicle have been largely overlooked.

For example, in US patent 2007/0151644 A1, an oval-shaped tread pattern is shown. While oval shaped tread lugs have the potential to reduce drag, their closely spaced pattern shown diverts most of the air to flow over the top surfaces of the tire, rather than between the lugs. Moreover, the closely spaced oval lugs are designed to reduce stresses during tire compression—thereby improving the rolling resistance of the tire—and to reduce the incidence of trapping stones between the lugs. As such, the minimally spaced lugs are an essential characteristic of this embodiment. As disclosed, any minor improvement in the aerodynamic characteristics of the tire was not included.

### SUMMARY

An embodiment comprises tire having aerodynamically optimized tread blocks disposed in an aerodynamically optimized pattern, reducing drag from headwinds on critical upper drag-inducing tire surfaces, and thereby reducing the total drag-induced resistive forces upon the wheel assembly and minimizing needed vehicle propulsive counter-forces.

An embodiment comprises a method for optimally minimizing the total drag-induced resistive forces upon the wheel assembly of a vehicle, and thereby minimizing needed vehicle propulsive counter-forces.

### DESCRIPTION OF THE DRAWINGS

While one or more aspects pertain to most wheeled vehicles not otherwise having fully shielded wheels that are completely protected from oncoming headwinds, the embodiments can be best understood by referring to the following figures.

FIG. 1 is a front cycle wheel assembly, as typically found on a bicycle or motorcycle, where a fairing is attached and positioned as shown to each interior side of the fork assembly, thereby shielding the upper- and front-most surfaces of the spoked wheel from oncoming headwinds.

FIG. 17 shows a plot of calculated average moments—about the ground contact point—of drag force, that are exerted upon rotating wheel surfaces as a function of the elevation above the ground. The relative drag forces are determined from calculated wind vectors for the rotating surfaces on a wheel moving at a constant speed of V, and plotted for several different wind and wheel-surface shielding conditions. Specifically, relative magnitudes in average drag moments about the ground contact point as a function of elevation are plotted, for eight conditions: comparing with (dashed lines) and without (solid lines) shielding covering the upper third of wheel surfaces, for tailwinds equal to half the vehicle speed; for null headwinds; for headwinds equal to half the vehicle speed; and for headwinds equal to the vehicle speed. The rising solid curves plotted show the highest moments to be near the top of the wheel, while the dashed curves show the effect of the upper shield in substantially reducing the average drag moments on the rotating wheel.

FIG. 18 shows a plot of calculated relative drag torque exerted upon rotating wheel surfaces as a function of elevation above the ground. The relative total drag torques are determined from the calculated average moments in combination with the chord length at various elevations on a wheel moving at a constant speed of V, for several different wind and wheel-surface shielding conditions. Relative magnitudes in total drag torque about the ground contact point as a function of elevation are plotted for eight conditions: comparing with (dashed lines) and without (solid lines) shielding covering the upper third of wheel surfaces, for tailwinds equal to half the vehicle speed; for null headwinds; for headwinds equal to half the vehicle speed; and for headwinds equal to the vehicle speed. The areas under the plotted curves represent the total torque from frictional drag on wheel surfaces. Comparing the differences in area under the plotted curves reveals the general trend of the upper shield to substantially reduce the total drag torque on the rotating wheel.

FIG. 19 shows a tapered spoke for use on a typical racing bicycle wheel. The spoke is shown tapering from a highly elliptical cross-sectional profile located nearest the wheel rim—shown at the top of the figure—to a more circular cross-sectional profile located on the spoke nearest the wheel central hub—shown at the bottom of the figure.

FIG. 20 shows a side view of the tapered spoke of FIG. 19.

FIG. 21 shows the highly elliptical cross section A-A of the tapered spoke shown in FIGS. 19 and 20.

FIG. 22 shows the more oval cross section B-B of the tapered spoke shown in FIGS. 19 and 20.

FIG. 23 shows the near circular cross section C-C of the tapered spoke shown in FIGS. 19 and 20.

FIG. 24 is a diagram of a wheel rolling on the ground representing typical prior art models, showing the net pressure drag force (P) exerted upon the forward wheel vertical profile—which moves at the speed of the vehicle—being generally centered near the axle of the wheel and balanced against the propulsive force (A) applied at the axle.

FIG. 25 is a diagram of a wheel rolling on the ground, showing the net friction drag force (F) upon the wheel surfaces—which move at different speeds depending on the elevation from the ground—being offset from the axle and generally centered near the top of the wheel. A ground reaction force (R)—arising due to the drag force being offset near the top of the wheel—is also shown. The force (A) applied at the axle needed to overcome the combination of drag forces (F+P) and reaction force (R) is also shown.

FIG. 26 shows a tire with an off-road tread pattern typical of prior art, having relatively sharp, angular, non-aerodynamic both windward- and leeward-facing sides on each tread block.

FIG. 27 shows an aerodynamic tread pattern with aggressive tread blocks having relatively sharp, angular, non-aerodynamic windward-facing sides for traction, and more smooth and streamlined leeward-facing sides for minimizing drag. The tread blocks are shown separated and offset longitudinally in order to partially redirect air flowing from the front leading surface of one block toward the rear trailing surface of an adjacent block, thereby reducing pressure drag on the adjacent block.

FIG. 28 shows an aerodynamic tread pattern with aggressive tread blocks having relatively sharp, angular, non-aerodynamic windward-facing sides for traction, and more smooth and streamlined leeward-facing sides for minimizing drag. The tread blocks are show separated and offset longitudinally in an oblique arrangement, in order to partially redirect air flowing from the front leading surface of one block toward the rear trailing surface of an adjacent block—thereby reducing pressure drag on the adjacent block—and toward the outside of the tire.

FIG. 29 shows an aerodynamic tread pattern with aggressive tread blocks having oval-shaped tread blocks oriented with wider sides positioned laterally for more traction, while having a substantially streamlined profiles for minimizing drag. Such a symmetrical tread pattern allows for bi-directional mounting on a vehicle. The tread blocks are shown separated and offset sufficiently in order to partially redirect air flowing from the front leading surface of one block toward the rear trailing surface of an adjacent block, thereby reducing pressure drag on the adjacent block.

FIG. 30 shows an aerodynamic tread pattern with aggressive tread blocks having oval-shaped tread blocks oriented with wider sides positioned longitudinally for more drag reduction, and having a substantially streamlined profiles for minimizing drag. Such a symmetrical tread pattern allows for bi-directional mounting on a vehicle. The tread blocks are shown separated and offset sufficiently in order to partially redirect air flowing from the front leading surface of one block toward the rear trailing surface of an adjacent block, thereby reducing pressure drag on the adjacent block.

### DETAILED DESCRIPTION

A reference embodiment from a parent application is first described in detail in order to present an operational description of how drag reduction specifically on the upper wheel surfaces dramatically improves vehicle propulsion. Through similar means, the drag reduction on the upper wheel surfaces provided by the embodiment of this application similarly improves vehicle propulsion under a variety of wind conditions.

### Reference Embodiment

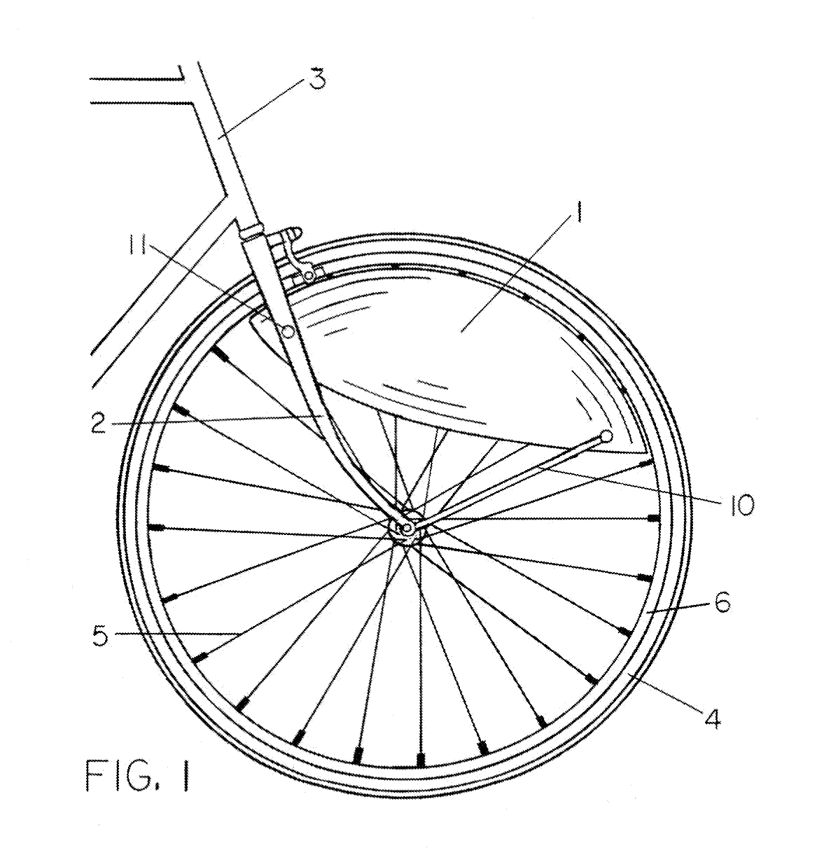

### Description—FIG. 1

As shown in FIG. 1, a streamlined fairing 1 is attached to the inside of a front fork tube assembly 2 of a typical bicycle 3 having spoked wheels 4. The fairing 1 is positioned closely adjacent to the inside structure of wheel 4, covering much of the upper and front-most quadrant of the wheel 4 as shown, and is rigidly fixed to front-fork tube assembly 2 using fastener 11 and strut 10. While only one fairing 1 is shown, the embodiment will generally include a similar fairing 1 located on the opposite side of the wheel 4, thereby shielding the entire upper inner structure of wheel 4 from the oncoming wind caused by forward motion of cycle 3. The fairing 1 has sufficient structural rigidity to allow close placement to spokes 5 and rim 6 of the wheel 4, thereby minimizing oncoming wind from leaking into the inner structure of wheel 4.

With fairing 1 configured in this way, the spokes 5 positioned near the top of the wheel 4 are shielded from headwinds. Shielded in this way, the topmost spokes 5 are moving at an effective wind speed generally less than or equal to the ground speed of the cycle 3, rather than moving at an effective headwind speed of up to nearly twice the ground speed of cycle 3. As a result, the aerodynamic drag forces exerted upon the topmost spokes 5 are greatly reduced.

The reduction in drag force due to fairing 1 is generally greater near the top of the wheel 4, where the spokes 5 are moving fastest with respect to headwinds otherwise impinging thereupon. As uppermost spokes 5 rotate away from the topmost point to an intermediate position with respect to either of the two lateral mid-points at the height of the axle on the wheel 4, these headwind drag forces are greatly reduced.

The embodiment shown in FIG. 1 includes a minimal fairing 1 positioned closely adjacent to the wheel, and shielding generally the most critical upper and forward-oriented quadrant of wheel 4, minimizing the addition of unnecessary weight or drag-inducing structure to cycle 3.

The fairing 1 shown extends sufficiently rearward to provide a measure of profile shielding of the rear portion of the wheel and spokes, diverting the wind from impinging directly the rear rim of the wheel, and thereby permitting a generally streamlined flow to be maintained across the entire upper section of wheel assembly.

### Reference Embodiment

### Operation FIGS. 1, 17, 18, 23 and 24

The shielding provided by fairing 1 is particularly effective since aerodynamic forces exerted upon exposed vehicle surfaces are generally proportional to the square of the effective wind speed impinging thereon. Moreover, the power required to overcome these drag forces is generally proportional to the cube of the effective wind speed. Thus, it can be shown that the additional power required to overcome these drag forces in propelling a vehicle twice as fast over a fixed distance, in half the time, increases by a factor of eight. And since this power requirement is analogous to rider effort—in the case of a bicycle rider—it becomes critical to shield the most critical drag-inducing surfaces on a vehicle from oncoming headwinds.

In any wheel used on a vehicle, and in the absence of any external headwinds, the effective horizontal wind speed at a point on the wheel at the height of the axle is equal to the ground speed of the vehicle. Indeed, the effective headwind speed upon any point of the rotating wheel depends on that point's current position with respect to the direction of motion of the vehicle.

Notably, a point on the moving wheel coming into direct contact with the ground is necessarily momentarily stationary, and therefore is not exposed to any relative wind speed, regardless of the speed of the vehicle. While the ground contact point can be rotating, it is not translating; the contact point is effectively stationary. And points on the wheel nearest the ground contact point are translating with only minimal forward speed. Hence, drag upon the surfaces of the wheel nearest the ground is generally negligible.

Contrarily, the topmost point of the wheel assembly (opposite the ground) is exposed to the highest relative wind speeds: generally at least twice that of the vehicle speed. And points nearest the top of the wheel are translating with forward speeds substantially exceeding the vehicle speed. Thus, drag upon the surfaces of the upper wheel can be quite substantial. Lower points on the wheel are exposed to lesser effective wind speeds, approaching a null effective wind speed—and thus negligible drag—for points nearest the ground.

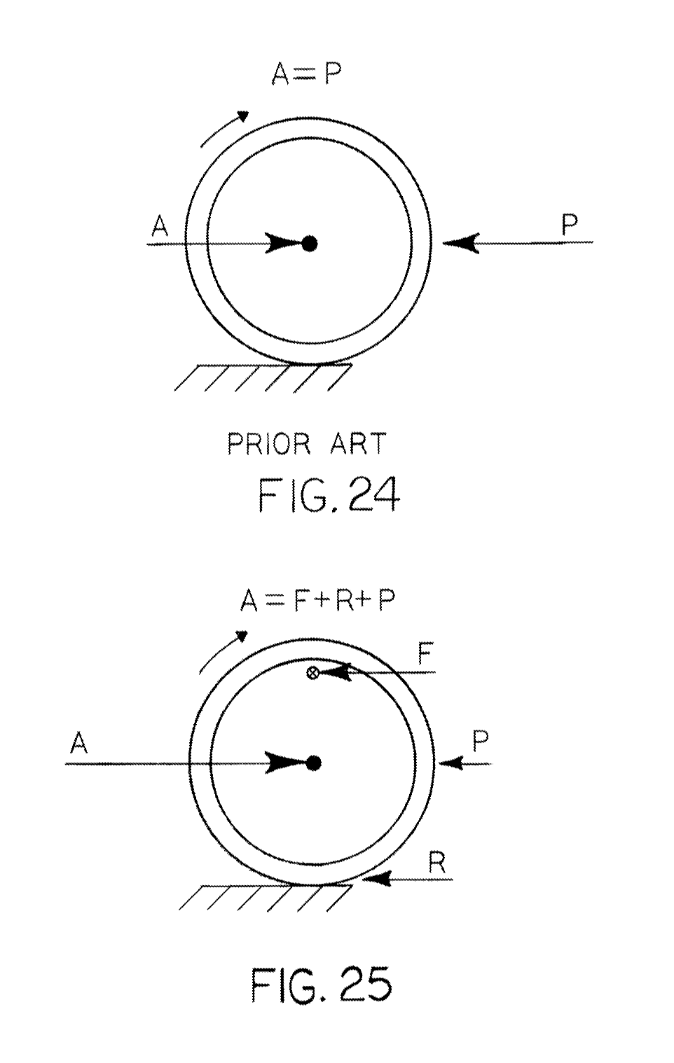

Importantly, due to the rotating geometry of the wheel, it can be shown that the effective combined frictional drag force exerted upon the wheel is typically centered in closer proximity to the top of the wheel, rather than centered closer to the axle as has been commonly assumed in many past analyses of total wheel drag forces. While the net pressure (or form) drag (P) force on the forwardly facing profile of the wheel is generally centered with elevation and directed near the axle on the wheel (as shown in FIG. 24), the net frictional drag force (F) upon the moving surfaces is generally offset to near the top of the wheel (as shown in FIG. 25).

Indeed, it is near the top of the wheel where the relative winds are both greatest in magnitude, and are generally oriented most directly opposed to the forward motion of rotating wheel surfaces. Moreover, in the absence of substantial external headwinds, the frictional drag exerted upon the lower wheel surfaces contributes relatively little to the net drag upon the wheel, especially when compared to the drag upon the upper surfaces. The combined horizontal drag forces (from pressure drag from headwinds deflected by both the leading and trailing wheel forwardly facing profiles, and from frictional drag from headwinds impinging upon the forwardly moving surfaces) are thus generally concentrated near the top of the wheel under typical operating conditions. Moreover, with the faster relative winds being directed against the uppermost wheel surfaces, total drag forces combine near the top to exert considerable retarding torque upon the wheel.

As mentioned, the horizontal drag forces are primarily due to both pressure drag forces generally distributed symmetrically across the forwardly facing vertical profiles of the wheel, and to winds in frictional contact with moving surfaces of the wheel. Pressure drag forces arise primarily from the displacement of air from around the advancing vertical profile of the wheel, whose circular outline moves at the speed at the vehicle. As discussed above, since the entire circular profile moves uniformly at the vehicle speed, the displacement of air from around the moving circular profile is generally uniformly distributed with elevation across the forwardly facing vertical profile of the wheel. Thus, these pressure drag forces (P, as shown in FIG. 24 and FIG. 25) are also generally evenly distributed with elevation across the entire forwardly facing vertical profile of the wheel, and centered near the axle. And these evenly distributed pressure drag forces arise generally in proportion only to the effective headwind speed of the vehicle.

Frictional drag forces (F, as shown FIG. 25), however, are concentrated near the top of the wheel where moving surfaces generally exceed vehicle speed—while the lower wheel surfaces move at less than the vehicle speed. Since drag forces are generally proportional to the square of the effective wind speed, it becomes apparent that with increasing wind speed, that these upper wheel frictional drag forces directed upon the moving surfaces increase much more rapidly than do pressure drag forces directed upon the forward profile of the wheel. Indeed, these friction drag forces generally arise in much greater proportion to an increasing effective headwind speed of the vehicle. Nevertheless, these increased frictional drag forces being directed on the upper wheel is only a partial factor contributing to augmented wheel drag forces being responsible for significantly retarded vehicle motion.

Significantly, both types of drag forces can be shown to exert moments of force pivoting about the point of ground contact. And as such, either type of drag force exerted upon the upper wheel retards vehicle motion considerably more than a similar force exerted upon a substantially lower surface of the wheel. Minimizing these upper wheel drag forces is therefore critical to improving propulsive efficiency of the vehicle.

Also important—and due to the rotating geometry of the wheel—it can be shown that the vehicle propulsive force on the wheel applied horizontally at the axle must substantially exceed the net opposing drag force exerted near the top of the wheel. These forces on a wheel are actually leveraged against each other, both pivoting about the same point—the point on the wheel which is in stationary contact with the ground—and which is constantly changing lateral position with wheel rotation. Indeed, with the geometry of a rolling wheel momentarily pivoting about the stationary point of ground contact, the lateral drag and propulsive forces each exert opposing moments of force on the wheel centered about this same point in contact with the ground.

Furthermore, unless the wheel is accelerating, the net torque from these combined moments on the wheel must be null: The propulsive moment generated on the wheel from the applied force at the axle must substantially equal the opposing moment from drag forces centered near the top of the wheel (absent other resistive forces, such as bearing friction, etc.). And the propulsive moment generated from the applied force at the axle has a much shorter moment arm (equal to the wheel radius) than the opposing moment from the net drag force centered near the top of the wheel (with a moment arm substantially exceeding the wheel radius)—since both moment arms are pivoting about the same stationary ground contact point. Thus, for these opposing moments to precisely counterbalance each other, the propulsive force applied at the axle—with the shorter moment arm—must substantially exceed the net drag force near the top of the wheel.

In this way, the horizontal drag forces exerted upon the upper surfaces of the wheel are leveraged against opposing and substantially magnified forces at the axle. Hence, a relatively small frictional drag force centered near the top of the wheel can have a relatively high impact on the propulsive counterforce required at the axle. Shielding these upper wheel surfaces can divert much of these headwind-induced drag forces directly onto the vehicle body, thereby negating much of the retarding force amplification effects due to the pivoting wheel geometry.

Moreover, since the propulsive force applied at the axle exceeds the combined upper wheel drag forces, a lateral reaction force (R, as shown in FIG. 25) upon the wheel is necessarily developed at the ground contact point, countering the combined unbalanced propulsive and drag forces on the wheel: Unless the wheel is accelerating, the reaction force at the ground, together with the upper wheel net drag forces (F+P), combine (A=F+R+P, as shown in FIG. 25) to countervail the lateral propulsive force (A) applied at the axle. This reaction force is transmitted to the wheel through frictional contact with the ground. In this way, an upper wheel drag force is further magnified against the axle. For these multiple reasons, it becomes crucial to shield the upper wheel surfaces from exposure to headwinds.

Given that the propulsive force (A) applied at the axle must overcome both the net wheel drag forces (F+P) and the countervailing lower reaction force (R) transmitted through the ground contact point, it can be shown that the net drag force upon the upper wheel can oppose vehicle motion with nearly twice the sensitivity as an equivalent drag force upon the static frame of the vehicle. Hence, shifting the impact of upper wheel drag forces to the static frame can significantly improve the propulsive efficiency of the vehicle.

Furthermore, as drag forces generally increase in proportion to the square of the effective wind speed, the more highly sensitive upper wheel drag forces increase far more rapidly with increasing headwind speeds than do vehicle frame drag forces. Thus, as the vehicle speed increases, upper wheel drag forces rapidly become an increasing component of the total drag forces retarding vehicle motion.

And given the greater sensitivity of speed-dependent upper wheel drag forces—as compared against vehicle frame drag forces—to the retarding of vehicle motion, considerable effort should first be given to minimizing upper wheel drag forces. And shielding the faster-moving uppermost surfaces of the wheel assembly from oncoming headwinds, by using the smallest effective fairing assembly, is an effective means to minimize upper wheel drag forces.

Contrarily, drag forces on the lower wheel generally oppose vehicle motion with reduced sensitivity compared to equivalent drag forces on the static frame of the vehicle. Propulsive forces applied at the axle are levered against lower wheel drag forces, magnifying their impact against these lower wheel forces. Shielding lower wheel surfaces can generally negate this mechanical advantage, and can actually increase overall drag on the vehicle.

Moreover, as discussed above, headwinds on the static frame generally exceed the speed of winds impinging the lower surfaces of the wheel. Hence, frictional drag forces on the lower wheel surfaces are greatly reduced. Thus, it is generally counterproductive to shield the wheel below the level of the axle. Drag on a vehicle is generally minimized with upper wheel surfaces shielded from headwinds and with lower wheel surfaces exposed to headwinds.

Wheel drag sensitivity to retarding vehicle motion becomes even more significant in the presence of external headwinds. With external headwinds, the effective wind speed impinging the critical upper wheel surfaces can well exceed twice the vehicle speed. Shielding protects the upper wheel surfaces both from external headwinds, and from headwinds due solely to vehicle motion.

Indeed, wheel surfaces covered by the shield are exposed to winds due solely to wheel rotation; headwinds are deflected. The effective drag winds beneath the shield are generally directed tangentially to rotating wheel surfaces, and vary in proportion to radial distance from the axle, reaching a maximum speed at the wheel rim equal to the vehicle speed, regardless of external headwinds. Since drag forces vary generally in proportion to the square of the wind speed, the frictional drag forces are considerably reduced on shielded upper wheel surfaces. Using these wind shields, shielded wheel surfaces are exposed to substantially reduced effective wind speeds—and to generally much less than half of the drag forces without shielding.

Diminished drag forces from external headwinds impinging the slower moving lower surfaces of a rolling wheel generally oppose wheel motion with much less retarding torque than drag forces from winds impinging the faster upper surfaces. Indeed, tests demonstrate that with upper shields installed on a suspended bicycle wheel, the wheel will spin naturally in the forward direction when exposed to headwinds. Without the shields installed, the same wheel remains stationary when exposed to headwinds, regardless of the speed of the headwind. And an unshielded spinning wheel will tend to stop spinning when suddenly exposed to a headwind. This simple test offers an explanation for the unexpected result achieved from Greenwell—mentioned above—and demonstrates that by minimally shielding only the upper wheel surfaces from external headwinds, the overall drag upon the rotating wheel can be substantially reduced.

Furthermore, as external headwinds upon a forwardly rotating vehicle wheel add relatively little frictional drag to the lower wheel surfaces—which move forward at less than the vehicle speed—but add far more significant drag to the upper wheel surfaces, which move forward faster than the vehicle speed and which can more significantly retard vehicle motion, shielding the upper wheel surfaces against headwinds is particularly beneficial. Since drag forces upon the wheel are generally proportional to the square of the effective wind speed thereon, and the additional drag on the wheel—and thereby on the vehicle—increases rapidly with headwinds, shielding these upper surfaces greatly reduces the power required to propel the vehicle. Moreover, the relative effectiveness of shielding upper wheel surfaces generally increases with increasing headwinds.

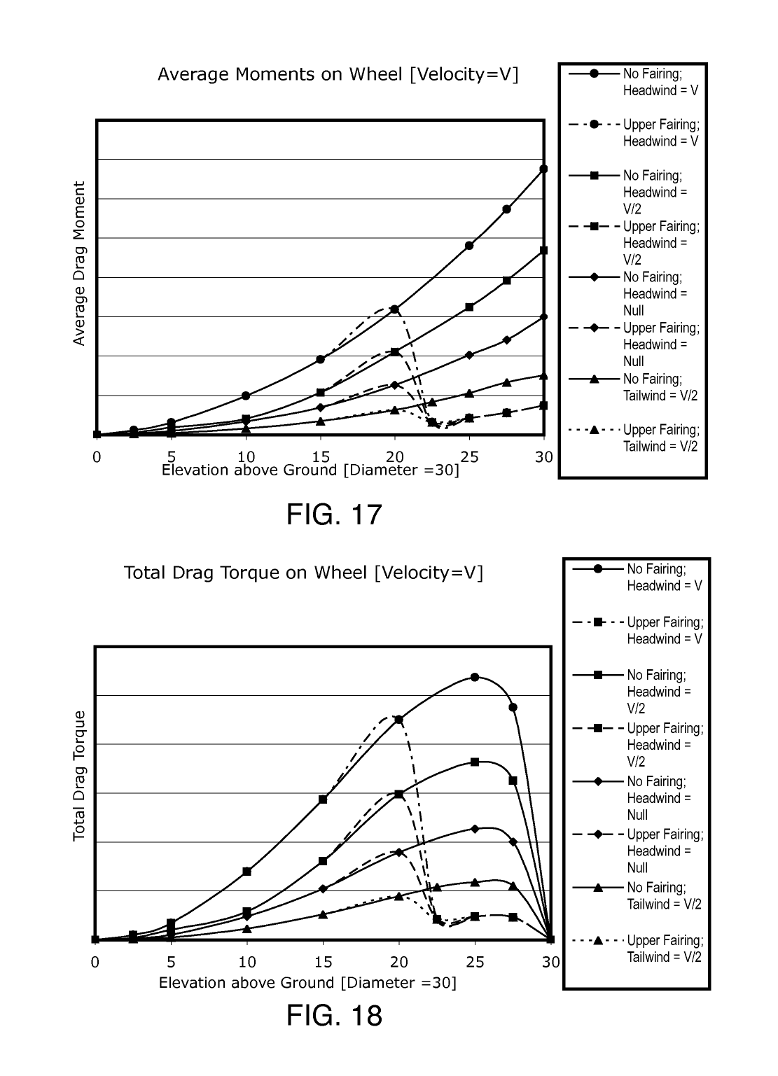

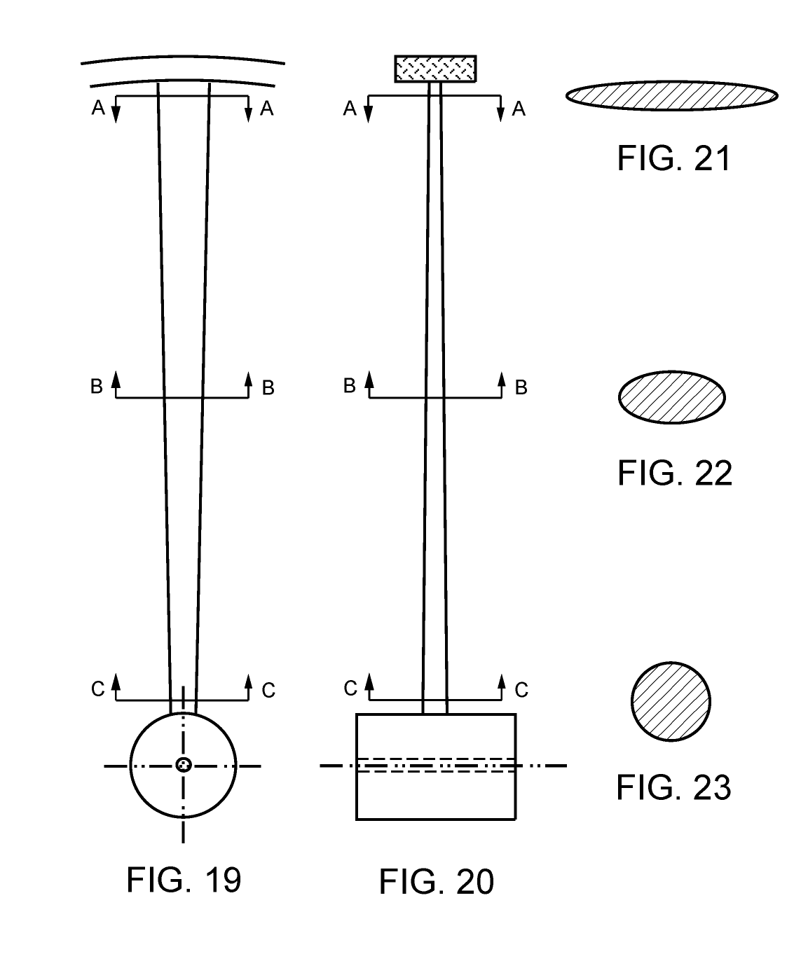

An examination of the retarding wind vectors on a rotating wheel can reveal the large magnitude of drag retarding moments upon the uppermost wheel surfaces, relative to the lower wheel surfaces. And an estimate of the frictional drag torque on the wheel can be determined by first calculating the average moments due to drag force vectors at various points—all pivoting about the ground contact point—on the wheel (results shown plotted in FIG. 17), and then summing these moments at various wheel elevations above the ground and plotting the results (FIG. 18). The area under the resulting curve (shown in FIG. 18 as a series of curves representing various headwind conditions) then represents the total frictional drag (absent profile drag) torque upon the wheel.

In order to determine the relationship between this torque and elevation on the wheel, the magnitudes of the drag wind vectors that are orthogonal to their corresponding moment arms pivoting about the point of ground contact must first be determined. These orthogonal vector components can be squared and then multiplied by the length of their corresponding moment arms, in order to determine the relative moments due to drag at various points along the wheel rim.

The orthogonal components of these wind vectors tend to increase linearly with elevation for points on the rim of the wheel, and also for points along the vertical mid-line of the wheel. Calculating the moments along the vertical mid-line of the wheel can yield the minimum relative drag moments at each elevation. Calculating an average of the maximum drag moment at the rim combined with the minimum drag moment along the mid-line can then yield the approximate average drag moment exerted at each elevation upon the wheel. Multiplying this average drag moment by the horizontal rim-to-rim chord length can yield an estimate of the drag torque exerted upon the wheel at each elevation level (FIG. 18). These calculations are simply determined from the geometry of the rotating wheel; the object of this analysis is to determine the likely relative magnitudes of drag torques upon the wheel at various elevations.

From the resulting plots (FIG. 18), it can be estimated that the uppermost approximate one-third section of the wheel likely contributes most of the overall drag torque upon the wheel. Thus, by shielding this upper section from headwinds, drag torque can be considerably reduced. With upper-wheel shielding, as noted above, the relative winds beneath the shield are due mostly to wheel rotation, and are generally directed tangentially to the wheel. The resulting drag torque under the shielded sections can then be determined as above, and compared with the unshielded drag torque for similar headwind conditions.

These calculations—generally confirmed by tests—indicate a substantial reduction in retarding drag torque upon the shielded upper wheel surfaces. In the absence of external headwinds, the plots of FIG. 18 indicate that shielding the uppermost approximate one-third section of the wheel can reduce the drag torque of this section considerably, by as much as 75 percent. Moreover, repeating calculations and testing with an external headwind equal to the vehicle speed indicates that upper wheel shielding can reduce the comparative upper wheel drag torque of this section by still more, perhaps by as much as 90 percent. Hence, the potential effectiveness of shielding upper wheel surfaces can be significant, especially with surfaces having higher drag sensitivities, such as wheel spoke surfaces.

As discussed above, since upper wheel drag forces are leveraged against the axle—thereby magnifying the propulsive counterforce required at the axle—an increase in drag force on the wheels generally retards vehicle motion much more rapidly than does an increase in other vehicle drag forces. And while under external headwind conditions, the total drag on a vehicle with wheels exposed directly to headwinds increases still more rapidly with increasing vehicle speed.

Shielding upper wheel surfaces effectively lowers the elevation of the point on the wheel where the effective net drag force is exerted, thereby diminishing the magnifying effect of the propulsive counterforce required at the axle, as discussed above. As a result, the reduction in drag force upon the vehicle achieved by shielding the upper wheel surfaces is comparatively even more significant with increasing external headwinds. Shielding these upper wheel surfaces can thereby improve relative vehicle propulsion efficiency under headwinds by an even greater margin than under null wind conditions.

Moreover, shielding these upper wheel surfaces can be particularly beneficial to spoked wheels, as round spokes can have drag sensitivities many times greater than that of more streamlined surfaces. As round spokes—in some configurations—can have drag coefficients ranging from one to two orders of magnitude greater than corresponding smooth, streamlined surfaces, shielding the spokes of the upper wheel from external wind becomes particularly crucial in reducing overall drag upon the wheel.

Accordingly—given these multiple factors—a relatively small streamlined fairing attached to the vehicle structure and oriented to shield the upper surfaces of the wheel assembly from oncoming headwinds substantially reduces drag upon the wheel, while minimizing total drag upon the vehicle. Consequently, an embodiment includes the addition of such a fairing to any wheeled vehicle—including vehicles having spoked wheels, where the potential drag reduction can be even more significant.

The addition of such minimal fairings to each side of a traditional spoked bicycle wheel, for example, reduces windage losses and improves propulsive efficiency of the bicycle, particularly at higher cycle speeds or in the presence of headwinds, while minimizing cycle instability due to crosswind forces. Since crosswinds are a significant factor restricting the use of larger wheel covers, minimizing the fairing size is also an important design consideration. And minimizing form drag induced by the forward-facing profile of the fairing also will influence the fairing design. The preferred fairing size will likely substantially cover the upper section of the exposed wheel, and be placed closely adjacent to the wheel surfaces, consistent with general use in bicycles. In heavier or powered cycles, design considerations may permit somewhat larger fairings, covering even more of the wheel surfaces.

As shielding upper wheel surfaces can reduce overall drag on the vehicle, while simultaneously augmenting the total frontal profile area of the vehicle exposed to headwinds, a natural design constraint emerges from these competing factors: Shields should be designed sufficiently streamlined and positioned sufficiently close to wheel surfaces to provide reduced overall vehicle drag. And as shielding effectiveness potentially increases under headwind conditions, shields designed with larger surface areas and larger frontal profiles may still provide reduced overall vehicle drag under headwind conditions, if not under null wind conditions. Thus, a range of design criteria may be applied to selecting the best configuration and arrangement of the fairing, and will likely depend on the particular application. In any particular application, however, the embodiment will include a combination of design factors discussed above that will provide a reduction in overall vehicle drag.

In a cycle application, for example, fairings positioned within the width of the fork assembly will likely provide the most streamlined design which both shields spokes from headwinds but also minimizes any additional form drag profile area to the vehicle frame assembly. In other applications, insufficient clearances may preclude positioning the fairings immediately adjacent to moving wheel surfaces. In such situations, headwinds may be sufficient in magnitude to cause a reduction in overall vehicle drag to justify the use of wider upper wheel fairings—positioned largely outside the width of the fork assembly—with extended forward profile areas.

Furthermore, from the previous analysis a consideration the drag torque curves wholly above the level of the axle, it becomes apparent that shielding the wheel is best centered about an elevation likely between 75 and 80 percent of the diameter of the wheel, or near the center of the area under the unshielded torque curve shown in FIG. 18. While drag forces are generally greatest in magnitude near the top of the wheel, the effective exposed topmost surface areas are much smaller, thereby limiting the magnitude of drag torques upon the uppermost surfaces of the wheel. Thus, the upper wheel fairing would best extend above and below this critical level (generally, between 75 and 80 percent of the diameter of the wheel) in order to optimally minimize drag upon the wheel. And as the surfaces forward of the axle are the first to be impacted by headwinds, shielding these surfaces is essential to deflecting headwinds from the rearward surfaces. Thus, the higher-sensitivity drag-inducing surfaces in the forward upper quadrant and centered about this critical elevation on the wheel generally need to be shielded for optimal minimization of drag. These higher-sensitivity drag-inducing surfaces generally centered about this critical elevation and extending to include those surfaces with higher drag-inducing sensitivities that are positioned mostly in the forward upper quadrant of the wheel, but likely also to include much of the wheel surfaces positioned in the rearward upper quadrant, are herein defined and later referred to as: major upper drag-inducing surfaces. And the critical level about which the major drag-inducing surfaces are generally centered in elevation is herein defined and later referred to as: critical elevation.

As discussed, the precise elevation about which the major upper drag-inducing surfaces are centered, as well as the precise extent to which surfaces in the forward quadrant and in the upper half of the wheel central structure are included in the major upper drag-inducing surfaces, will depend on the particular application and operating conditions. Certain wheel surfaces with higher drag sensitivities, such as wheel spokes, generally need to be shielded when positioned within the region of the major upper drag-inducing surfaces. Other surfaces such as smooth tire surfaces having lower drag sensitivities may also benefit from shielding if their surface areas are extensive, are positioned near the critical level in elevation, or are the primary upper wheel surfaces exposed to headwinds. In the example analysis of FIGS. 17 and 18, a uniform surface across the wheel having a constant drag-sensitivity was assumed. In any particular application, the unique combination of different wheel surfaces with differing drag sensitivities will determine the particular height of the critical elevation level about which the major upper drag-inducing surfaces are centered.

A similar analysis can be performed for form drag forces on the moving forward vertical profiles of the wheel rim or tire. The results obtained are generally similar in form, though may differ somewhat in magnitudes as the effective wind speeds on the moving profiles are generally lower on the upper wheel—equal to the vehicle speed—and will depend on the particular application, including the total area of the wheel forward profile exposed to headwinds, and to headwind and vehicle speeds. Nevertheless, the net pressure drag torque caused by the moving outline of the wheel is also centered above the level of the axle, and thereby merits consideration in determining the particular height of the critical elevation level, and in the ultimate configuration of the fairing.

Hence, the fairing shown in FIG. 1 is best configured to shield the uppermost and forward wheel surfaces, and to extend rearward to at least partially shield the forward profile of the trailing portion of the upper wheel rim, consistent with the further requirement to extend downward as much as practical to the level of the axle. As mentioned, crosswind considerations will also influence the ultimate configuration for a particular application. In consideration of further embodiments described below, the operating principles described above will generally apply, and may be referred thereto.

### Present Embodiment

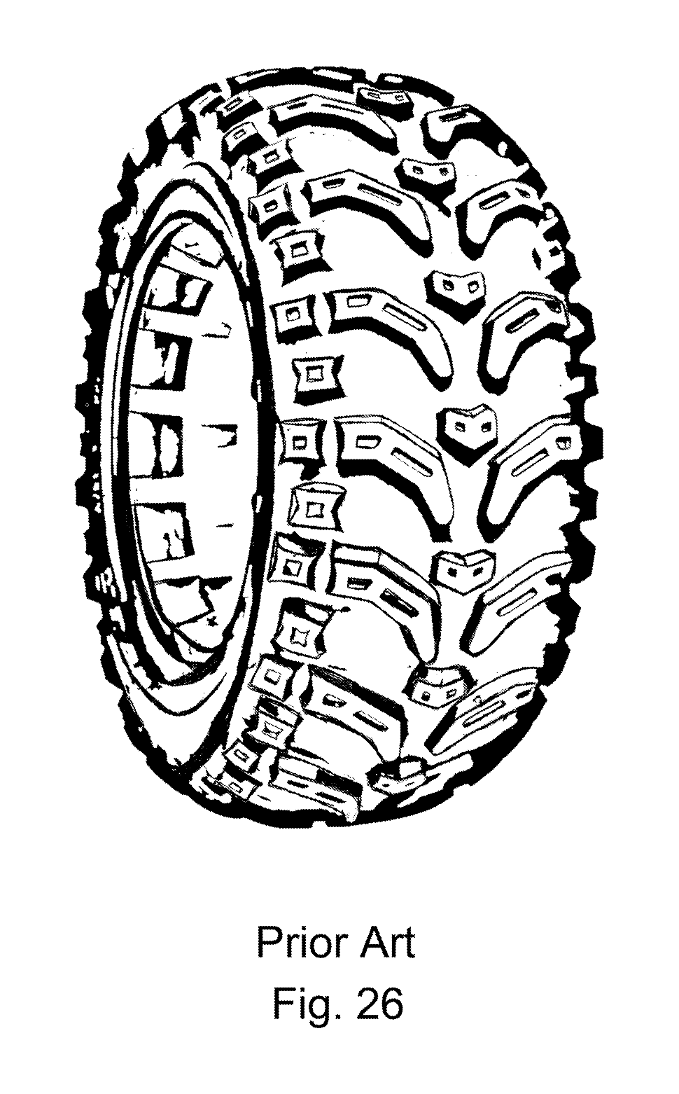

### FIGS. 26, 27, 28, 29 and 30

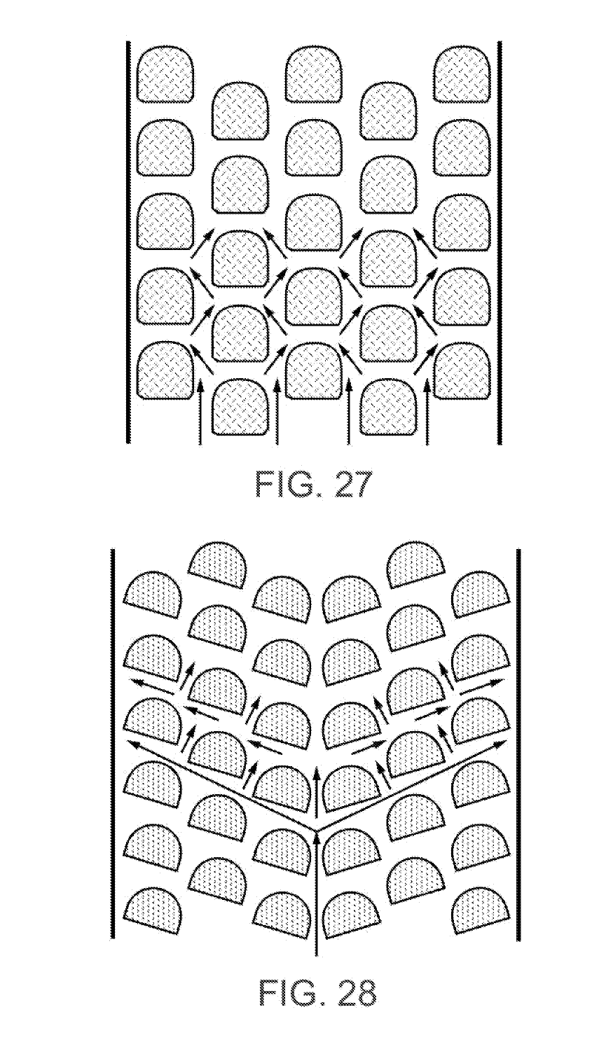

In FIG. 27, an aggressive tire tread block pattern is shown having tread blocks which taper smoothly in profile on the leeward side, thereby reducing drag. The tread blocks are spaced apart and arranged to permit air displaced by the tread to flow smoothly between, around and over each block, minimizing any flow separation—and thereby turbulence—behind each individual tread block. The relatively sharp, angular windward side of each block thereby provides for aggressive traction for typical off-road vehicle applications. However, the smoother leeward side of each tread block provides substantial streamlining for upper wheel drag reduction.

Tires using these streamlined tread blocks are thereby typically designed for unidirectional rotation, since using these tires in reverse rotation may reduce traction. Forward-facing windward surfaces of the tread blocks are generally sharp and angular in shape, and are thus optimized for maximum fraction on slippery ground; while the leeward, rearward-facing surfaces of the tread blocks are streamlined in design in order to reduce drag on each block.

The tread blocks are spaced and arranged to provide sufficient clearances to allow generally minimally restricted air flow there-between, such that air flowing near the top of the tire is deflected substantially between the tread blocks, rather than mostly over the top of the tire. Near the top of the wheel assembly within the forward quadrant, air flowing around one block is largely diverted between the blocks, with minimal diversion of air over the top surface of the block. And tread blocks are generally arranged to direct diverted air largely toward the leeward side of adjacent blocks. In this way, the pressure differential between the windward and leeward surfaces of tread blocks is further minimized, thereby reducing form drag on the tread blocks even more.

With tire tread blocks configured in this way, the tread near the top of tire is substantially streamlined for impinging headwinds. Form drag upon the tread blocks is thereby substantially reduced, both where winds most directly impinge the windward tread block surfaces, and where the fastest moving tread blocks are located—near the top of tire. As discussed above, these uppermost wheel surfaces are also the most critical drag-inducing surfaces retarding vehicle motion and increasing down-forces needed to maintain tire traction at higher speeds. Thus, it becomes crucial to minimize drag on these upper tire tread blocks. And streamlining tread patterns for this location on the wheel assembly is an effective means to improve propulsive efficiency of the vehicle, particularly at higher vehicle speeds.

Various configurations of tread patterns may incorporate streamlined tread blocks for reducing upper wheel drag forces against the tire. Tread blocks may taper either in width, depth or length. Alternative tread block patterns may incorporate more or less streamlined tapered lengths, depending on the application; longer streamlined blocks may reduce the total number of tread blocks available to cover the tire, enhancing drag reduction for higher speed applications at the expense of somewhat reduced tire traction. Contrarily, shorter streamlined blocks may increase the total number of tread blocks available to cover the tire, enhancing tire traction for slower speed applications at the expense of somewhat reduced drag reduction.

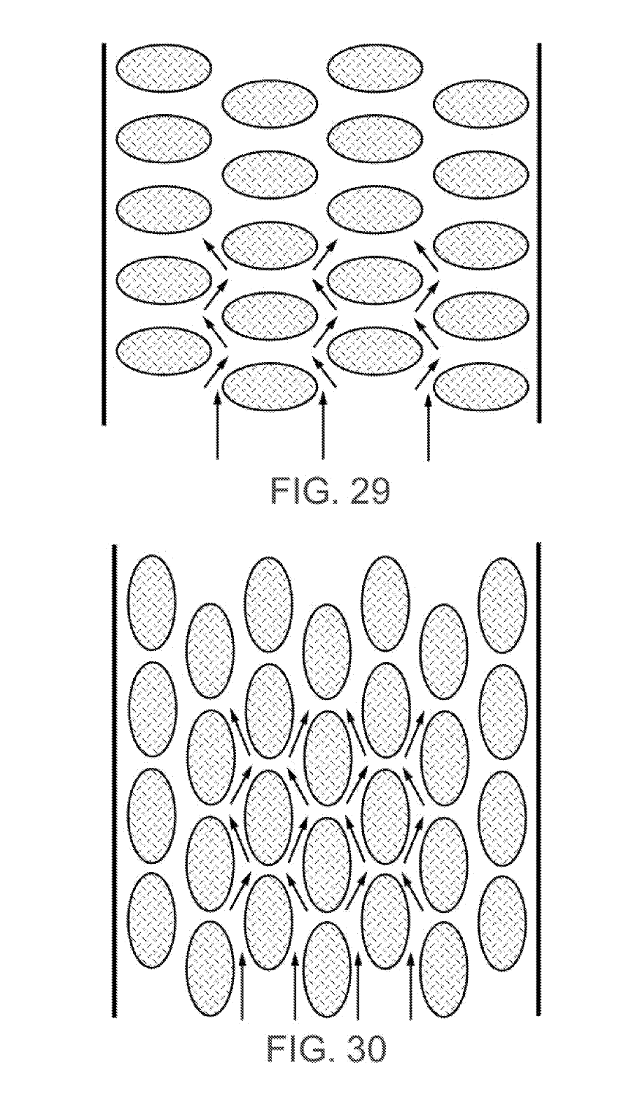

Windward tread block surfaces may also include somewhat oblique patterned arrangements—as shown in FIG. 28—rather than a more parallel orientation to the wheel axle often used to maximize traction. Alternatively, both windward and leeward tread block surfaces may include streamlined designs, with the blocks being more substantially oval in shape; the oval blocks can be shaped either symmetrically-similar from front to back such as in FIGS. 29 and 30, or the windward side can be shaped to be more sharp and angular, with the leeward surface being more streamlined and extended in length. In either case, sufficient clearance between the tread blocks must be maintained in order to enable substantial air flow there-between, and to enable pressure relief behind adjacent tread blocks, thereby minimizing form drag on the blocks. And for each of these embodiments, tread blocks are arranged in an aerodynamically optimized pattern.

And similar to other embodiments, the aerodynamic drag forces exerted upon the upper surfaces of tire are substantially reduced. Thus, this embodiment may offer dramatic reductions in vehicle drag, particularly for faster vehicles with aggressively treaded tires that are exposed directly to headwinds.

### CONCLUSIONS, RAMIFICATIONS, AND SCOPE

Exposed wheels can generate considerable drag forces on a moving vehicle. These forces are directed principally near the top of the wheel, rather than being more evenly distributed across the entire profile of the wheel. Moreover, these upper-wheel drag forces are levered against the axle, thereby magnifying the counterforce required to propel the vehicle. As a result, a reduction in drag upon the upper wheel generally enhances propulsive efficiency significantly more than a corresponding drag reduction on other parts of the vehicle.

With the net drag forces being offset and directed near the top of the wheel, nearly equivalent countervailing reaction forces—also opposing vehicle motion—are necessarily transmitted to the wheel at the ground. These reaction forces necessitate augmented down-forces to be applied in higher speed vehicles, in order to maintain static frictional ground contact and, thereby, vehicle traction and directional stability. As wings and other means typically used to augment these down-forces in such vehicles can add significant drag, it becomes evident that substantial effort should be made to reduce the upper wheel drag forces on most high-speed vehicles.

Wider tires with aggressive tread patterns, designed for maximizing traction rather than minimizing drag, contribute to significant drag in many off-road type vehicles. Such tires often have tread patterns with rectangular profiles, which thus suffer higher sensitivities to drag. These tires can be designed with more aerodynamic tread patterns, with the tread blocks shaped either more in an oval shape than a square or rectangular, or more tapered and streamlined on the leeward sides, thereby maintaining much of the traction of the rectangular profile tread tire. Furthermore, designing the gaps between the tread blocks for streamlined flow of headwinds around these tread blocks, could improve vehicle propulsive efficiencies. Moreover, the tread blocks could be shaped to freely divert some of the headwind to the side of the tire, especially for the upper forward profile section of the tire, rather than simply forcing the air up and over the tire, producing additional turbulence and more drag.

And as has been shown, the addition of minimal upper- and forwardly-oriented fairing and fender assemblies can substantially reduce total drag on the wheel, thereby enhancing the propulsive efficiency of the vehicle. Similarly, reducing drag through the use of an aerodynamic tread pattern on a tire can reduce vehicle drag, and should see widespread application on a range of different vehicles, from human-powered bicycles to high-speed motorcycles, automobiles, and trucks and trailers. The embodiments shown are poised to contribute not only to improved vehicle propulsive efficiency, but also to the worldwide effort to reduce vehicle fuel consumption—and thereby to conserve valuable energy resources.

The embodiment should not be limited to the specific examples illustrated and described above, but rather to the appended claims and their legal equivalents.

I claim:

1. An apparatus for reducing vehicle propulsory counterforces countervailing drag-induced resistive forces upon a terrestrial vehicle employing a wheel assembly, comprising:
a tire disposed on said wheel assembly with said tire oriented for minimal drag when said tire rotates forwardly;
said tire having tread blocks disposed in a patterned arrangement on said tire;
said tread blocks on either side of a centerline of said patterned arrangement positioned largely symmetically therein, with the centerline being perpendicular to the axle;
said tread blocks each having a ground-contacting profile of the same general shape;
said tread blocks each having a convex smoothly-varying aerodynamic ground-contacting profile shape on a predominately leeward-facing surface;
those said tread blocks on either one of said sides of the centerline positioned with the predominately longitudinal clearance there-between those said blocks not exceeding the predominately lateral clearance there-between those said blocks, where the longitudinal direction is parallel to the centerline;
those said tread blocks on either one of said sides of the centerline positioned with said predominately longitudinal clearance there-between those said blocks not exceeding half the predominate lateral width of those said tread blocks;
those said tread blocks on either one of said sides of the centerline positioned sufficiently far apart with sufficient clearance to permit minimally-restricted air flow from a headwind flowing there-between those said blocks when said blocks are positioned at the level of a critical elevation which is centered around the primary vehicle-drag-inducing wheel surface in a region of said wheel assembly positioned forward of the axle within a major upper drag-inducing surface of said wheel assembly located wholly above the level of the axle;
the critical elevation positioned not lower than a level equal to 75 percent of the outer diameter of said wheel assembly;
those said tread blocks on either one of said sides of the centerline positioned sufficiently close together with minimal clearance to redirect air flow from the headwind there-between those said blocks onto trailing leeward surfaces of adjacent said tread blocks in sufficient amount to substantially increase aerodynamic pressure on said trailing leeward surfaces in comparison to the aerodynamic pressure on forwardly-oriented windward surfaces of said adjacent tread blocks when said adjacent blocks are positioned at the level of the critical elevation in said forward region; and
said tread blocks located at the critical elevation in said forward region providing reduced drag on the major upper drag-inducing surface.

2. The apparatus of claim 1, further comprising:
a trailing first said adjacent tread block located at least partly rearwardly-offset from a leading second adjacent said tread block when said first and second blocks are positioned in said forward region of said wheel assembly;
said first and second blocks are positioned in said forward region at the level of the critical elevation;
said patterned arrangement of said first and second adjacent blocks adapted to divert the headwind flowing there-between from a windward-facing surface of said first trailing block toward a leeward-facing surface of said second leading block; and
wherein a reduction in the difference in air pressure between a windward-facing surface of said second block and the leeward-facing surface of said second block causes a reduction in drag force on said second block.

3. The apparatus of claim 1, further comprising:
a trailing first said adjacent tread block located at least partly rearwardly-offset from a leading second adjacent said tread block when said first and second blocks are positioned in said forward region of said wheel assembly;
said first and second blocks are positioned in said forward region at the level of the critical elevation;
said patterned arrangement of said first and second adjacent blocks adapted to divert the headwind flowing there-between from a windward-facing surface of said first trailing block toward a leeward-facing surface of said second leading block;
said blocks comprising sharp angular windward-facing surfaces; and
wherein a reduction in the difference in air pressure between a windward-facing surface of said second block and the leeward-facing surface of said second block causes a reduction in drag force on said second block.

4. The apparatus of claim 1, further comprising:
a trailing first said adjacent tread block located at least partly rearwardly-offset from a leading second adjacent said tread block when said first and second blocks are positioned in said forward region of said wheel assembly;
said first and second blocks are positioned in said forward region at the level of the critical elevation;
said patterned arrangement of said first and second adjacent blocks adapted to divert the headwind flowing there-between from a windward-facing surface of said first trailing block toward a leeward-facing surface of said second leading block;
said blocks comprising sharp angular windward-facing surfaces in oblique orientation to the axis of said wheel assembly wherein impinging air flow is directed in part laterally and rearwardly between said blocks toward an exterior lateral side of said tire; and
wherein a reduction in the difference in air pressure between a windward-facing surface of said second block and the leeward-facing surface of said second block causes a reduction in drag force on said second block.

5. The apparatus of claim 1, further comprising:
said tread blocks located at the critical elevation in said forward region providing reduced drag on the major upper drag-inducing surface wherein
the effective traction of said wheel assembly where contacting against the ground is increased and wherein
the upper wheel drag force from the headwind impinging on said tread blocks located in the vicinity of the primary vehicle-drag-inducing wheel surface in said forward region being applied higher on said wheel assembly near the level of the critical elevation than a propulsive counterforce being applied lower on said wheel assembly at the axle, and having a mechanical advantage over the propulsive counterforce since both the upper wheel drag force and the propulsive counterforce are levered in opposition about the same lowermost stationary point of ground contact on said wheel assembly with the moment arm of the upper wheel drag force being longer than the moment arm of the propulsive counterforce, a reduction in the upper wheel drag force from the headwind impinging on said tread blocks located in the vicinity of the primary-vehicle-drag-inducing wheel surface in said forward region, which also has stronger effective headwinds impinging thereon, is magnified by the mechanical advantage.

6. The apparatus of claim 1, further comprising a substantial proportion of those said tread blocks each having a convex smoothly-varying aerodynamic ground-contacting profile shape on a predominately windward-facing surface.

7. The apparatus of claim 1, further comprising:
a substantial proportion of those said tread blocks each having a convex smoothly-varying aerodynamic ground-contacting profile shape on a predominately windward-facing surface;
a trailing first said adjacent tread block located at least partly rearwardly-offset from a leading second adjacent said tread block when said first and second blocks are positioned in said forward region of said wheel assembly;
said first and second blocks are positioned in said forward region at the level of the critical elevation;
said patterned arrangement of said first and second adjacent blocks adapted to divert the headwind flowing there-between from a windward-facing surface of said first trailing block toward a leeward-facing surface of said second leading block; and
wherein a reduction in the difference in air pressure between a windward-facing surface of said second block and the leeward-facing surface of said second block causes a reduction in drag force on said second block.

8. The apparatus of claim 1, further comprising:
a substantial proportion of those said tread blocks each having a convex smoothly-varying aerodynamic ground-contacting profile shape on a predominately windward-facing surface;
a trailing first said adjacent tread block located at least partly rearwardly-offset from a leading second adjacent said tread block when said first and second blocks are positioned in said forward region of said wheel assembly;
said first and second blocks are positioned in said forward region at the level of the critical elevation;
said patterned arrangement of said first and second adjacent blocks adapted to divert the headwind flowing there-between from a windward-facing surface of said first trailing block toward a leeward-facing surface of said second leading block;
said blocks comprising sharp angular windward-facing surfaces; and
wherein a reduction in the difference in air pressure between a windward-facing surface of said second block and the leeward-facing surface of said second block causes a reduction in drag force on said second block.

9. The apparatus of claim 1, further comprising:
a substantial proportion of those said tread blocks each having a convex smoothly-varying aerodynamic ground-contacting profile shape on a predominately windward-facing surface;
a trailing first said adjacent tread block located at least partly rearwardly-offset from a leading second adjacent said tread block when said first and second blocks are positioned in said forward region of said wheel assembly;
said first and second blocks are positioned in said forward region at the level of the critical elevation;
said patterned arrangement of said first and second adjacent blocks adapted to divert the headwind flowing there-between from a windward-facing surface of said first trailing block toward a leeward-facing surface of said second leading block;
said blocks comprising sharp angular windward-facing surfaces in oblique orientation to the axis of said wheel assembly wherein impinging air flow is directed in part laterally and rearwardly between said blocks toward an exterior lateral side of said tire; and
wherein a reduction in the difference in air pressure between a windward-facing surface of said second block and the leeward-facing surface of said second block causes a reduction in drag force on said second block.

10. The apparatus of claim 1, further comprising a substantial proportion of those said tread blocks each having a smoothly-varying aerodynamic ground-contacting profile which is oval in shape.

11. An apparatus for reducing vehicle propulsory counterforces countervailing drag-induced resistive forces upon a terrestrial vehicle employing a wheel assembly exposed to headwinds impinging thereon above the level of an axle of the wheel assembly when the vehicle is in forward motion under a range of external headwind conditions, comprising:
a tire disposed on said wheel assembly with said tire oriented for minimal drag when said tire rotates forwardly;
said tire having tread blocks disposed in a patterned arrangement on said tire;
said tread blocks on either side of a centerline of said patterned arrangement positioned largely symmetically therein, with the centerline being perpendicular to the axle;
a majority of said tread blocks each having a ground-contacting profile of the same general shape;
a majority of said tread blocks each having a convex smoothly-varying aerodynamic ground-contacting profile shape on a predominately leeward-facing surface;
those majority said tread blocks on either one of said sides of the centerline positioned with the predominately longitudinal clearance there-between those said blocks not exceeding the predominately lateral clearance there-between those said blocks, where the longitudinal direction is parallel to the centerline;
those majority said tread blocks on either one of said sides of the centerline positioned with said predominately longitudinal clearance there-between those said blocks not exceeding half the predominate lateral width of those said tread blocks;
those majority said tread blocks on either one of said sides of the centerline positioned sufficiently far apart with sufficient clearance to permit minimally-restricted air flow from a headwind flowing there-between those said blocks when said blocks are positioned at the level of a critical elevation which is centered around the primary vehicle-drag-inducing wheel surface in a region of said wheel assembly positioned forward of the axle within a major upper drag-inducing surface of said wheel assembly located wholly above the level of the axle;
the critical elevation positioned not lower than a level equal to 75 percent of the outer diameter of said wheel assembly;
those majority said tread blocks on either one of said sides of the centerline positioned sufficiently close together with minimal clearance to redirect air flow from the headwind there-between those said blocks onto trailing leeward surfaces of adjacent said tread blocks in sufficient amount to substantially increase aerodynamic pressure on said trailing leeward surfaces in comparison to the aerodynamic pressure on forwardly-oriented windward surfaces of said adjacent tread blocks when said adjacent blocks are positioned at the level of the critical elevation in said forward region; and
those majority said tread blocks located at the critical elevation in said forward region providing reduced drag on the major upper drag-inducing surface wherein the vehicle propulsory counterforce needed to countervail an effective vehicle drag force comprising a mechanically magnified upper wheel drag force from the headwind impinging thereon is reduced when the vehicle is operated nominally under a range of external headwind conditions including null wind conditions.

12. The apparatus of claim 11, further comprising:
a trailing first majority said adjacent tread block located at least partly rearwardly-offset from a leading second adjacent majority said tread block when said first and second blocks are positioned in said forward region of said wheel assembly;
said first and second blocks are positioned in said forward region at the level of the critical elevation;
said patterned arrangement of said first and second adjacent blocks adapted to divert the headwind flowing there-between from a windward-facing surface of said first trailing block toward a leeward-facing surface of said second leading block; and
wherein a reduction in the difference in air pressure between a windward-facing surface of said second block and the leeward-facing surface of said second block causes a reduction in drag force on said second block.

13. The apparatus of claim 11, further comprising:
a trailing first majority said adjacent tread block located at least partly rearwardly-offset from a leading second adjacent majority said tread block when said first and second blocks are positioned in said forward region of said wheel assembly;
said first and second blocks are positioned in said forward region at the level of the critical elevation;
said patterned arrangement of said first and second adjacent blocks adapted to divert the headwind flowing there-between from a windward-facing surface of said first trailing block toward a leeward-facing surface of said second leading block;
said blocks comprising sharp angular windward-facing surfaces; and
wherein a reduction in the difference in air pressure between a windward-facing surface of said second block and the leeward-facing surface of said second block causes a reduction in drag force on said second block.

14. The apparatus of claim 11, further comprising:
a trailing first majority said adjacent tread block located at least partly rearwardly-offset from a leading second adjacent majority said tread block when said first and second blocks are positioned in said forward region of said wheel assembly;
said first and second blocks are positioned in said forward region at the level of the critical elevation;
said patterned arrangement of said first and second adjacent blocks adapted to divert the headwind flowing there-between from a windward-facing surface of said first trailing block toward a leeward-facing surface of said second leading block;
said blocks comprising sharp angular windward-facing surfaces in oblique orientation to the axis of said wheel assembly wherein impinging air flow is directed in part laterally and rearwardly between said blocks toward an exterior lateral side of said tire; and
wherein a reduction in the difference in air pressure between a windward-facing surface of said second block and the leeward-facing surface of said second block causes a reduction in drag force on said second block.

15. The apparatus of claim 11, further comprising a substantial proportion of those majority said tread blocks each having a smoothly-varying aerodynamic ground-contacting profile which is oval in shape.

16. The apparatus of claim 11, further comprising a substantial proportion of those majority said tread blocks each having a convex smoothly-varying aerodynamic ground-contacting profile shape on a predominately windward-facing surface.

17. The apparatus of claim 11, further comprising:
a substantial proportion of those majority said tread blocks each having a convex smoothly-varying aerodynamic ground-contacting profile shape on a predominately windward-facing surface;
a trailing first majority said adjacent tread block located at least partly rearwardly-offset from a leading second adjacent majority said tread block when said first and second blocks are positioned in said forward region of said wheel assembly;
said first and second blocks are positioned in said forward region at the level of the critical elevation;
said patterned arrangement of said first and second adjacent blocks adapted to divert the headwind flowing there-between from a windward-facing surface of said first trailing block toward a leeward-facing surface of said second leading block; and
wherein a reduction in the difference in air pressure between a windward-facing surface of said second block and the leeward-facing surface of said second block causes a reduction in drag force on said second block.

18. The apparatus of claim 11, further comprising:
a substantial proportion of those majority said tread blocks each having a convex smoothly-varying aerodynamic ground-contacting profile shape on a predominately windward-facing surface;
a trailing first majority said adjacent tread block located at least partly rearwardly-offset from a leading second adjacent majority said tread block when said first and second blocks are positioned in said forward region of said wheel assembly;
said first and second blocks are positioned in said forward region at the level of the critical elevation;
said patterned arrangement of said first and second adjacent blocks adapted to divert the headwind flowing there-between from a windward-facing surface of said first trailing block toward a leeward-facing surface of said second leading block;
said blocks comprising sharp angular windward-facing surfaces; and
wherein a reduction in the difference in air pressure between a windward-facing surface of said second block and the leeward-facing surface of said second block causes a reduction in drag force on said second block.

19. The apparatus of claim 11, further comprising:
a substantial proportion of those majority said tread blocks each having a convex smoothly-varying aerodynamic ground-contacting profile shape on a predominately windward-facing surface;
a trailing first majority said adjacent tread block located at least partly rearwardly-offset from a leading second adjacent majority said tread block when said first and second blocks are positioned in said forward region of said wheel assembly;
said first and second blocks are positioned in said forward region at the level of the critical elevation;
said patterned arrangement of said first and second adjacent blocks adapted to divert the headwind flowing there-between from a windward-facing surface of said first trailing block toward a leeward-facing surface of said second leading block;
said blocks comprising sharp angular windward-facing surfaces in oblique orientation to the axis of said wheel assembly wherein impinging air flow is directed in part laterally and rearwardly between said blocks toward an exterior lateral side of said tire; and
wherein a reduction in the difference in air pressure between a windward-facing surface of said second block and the leeward-facing surface of said second block causes a reduction in drag force on said second block.

20. In combination, a terrestrial vehicle employing a wheel assembly exposed to headwinds impinging substantially unimpeded above the level of an axle directly upon a forward-facing circumferential surface of a tire of said wheel assembly when the vehicle is in forward motion under a range of external headwind conditions and a means for reducing vehicle propulsory counterforces countervailing drag-induced resistive forces upon said wheel assembly by reducing drag from a headwind impinging substantially unimpeded directly on a critical wheel surface comprising a substantial proportion of a primary drag-inducing circumferential portion of a major upper drag-inducing surface comprising the primary vehicle-drag-inducing wheel surface which is centered about a critical elevation of said wheel assembly located wholly above the level of the axle,
with said drag-inducing circumferential portion also being located in a region of said wheel assembly positioned forward of the axle and being centered extending both above and below centered around the level of the critical elevation,
and with the critical wheel surface comprising a substantial proportion of the primary vehicle-drag-inducing wheel surface,
and with the critical elevation positioned not lower than a level equal to 75 percent of the outer diameter of said wheel assembly,
and with the critical wheel surface extending downwards both to include surfaces thereof positioned substantially lower than the critical elevation and to include the substantial proportion of said circumferential portion of the major upper drag-inducing surface while not extending lower than a minimum level located midway between the critical elevation and the axle,
and with the critical wheel surface also extending above the level of the critical elevation,
and with said means attached to and rotating with said wheel assembly,
and with said means providing said wheel assembly with tractional contact with the ground when said means is positioned at the lowermost point on said wheel assembly,
and with said means providing reduced drag on a front-facing upper circumferential surface of a tire of said wheel assembly from the headwind impinging thereon when said means is positioned both forward of the axle and at the critical elevation within an upper region of said wheel assembly comprising the major upper drag-inducing surface wherein the vehicle propulsory counterforce needed to countervail a mechanically magnified upper wheel drag force from the headwind impinging on the critical wheel surface is reduced when the vehicle is operated nominally under a range of external headwind conditions including null headwind conditions.
